(19) United States
(12) Patent Application Publication
(10) Pub. No.: US 2019/0372272 A1
(43) Pub. Date: Dec. 5, 2019

(54) CONNECTOR

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventors: Hajime MATSUI, Yokkaichi (JP); Yasuo OMORI, Yokkaichi (JP); Tetsuya MIYAMURA, Yokkaichi (JP)

(73) Assignees: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-shi, Osaka (JP)

(21) Appl. No.: 16/477,165

(22) PCT Filed: Dec. 25, 2017
(86) PCT No.: PCT/JP2017/046343

§ 371 Date: Jul. 10, 2019

(30) Foreign Application Priority Data
Jan. 13, 2017 (JP) 2017-003972

(51) Int. Cl. H01R 13/64; H01R 13/631

(52) U.S. Cl. CPC H01R 13/64; H01R 13/631

(57) ABSTRACT

In a connector, tabs (18) of male terminal fittings (16) are inserted into a female housing (30) and connected to female terminal fittings (34) by bringing a male housing (10) and the female housing (30) closer to each other in a facing positioning relationship. The male housing (10) is provided with a movable member (20) movable with the tabs (18) relatively displaceably passed therethrough, and a surface of the movable member (20) facing the female housing (30) is formed with a positioning projection (26), and a surface of the female housing (30) facing the movable member (20) is formed with a positioning recess (31) to be fit to the positioning projection (26) with front end parts of the tabs (18) passed through the movable member (20) and held out of contact with the female housing (30).

### BACKGROUND

### Field of the Invention

The invention relates to a connector.

### Related Art

Japanese Unexamined Patent Publication No. 2000-294333 discloses a connector configured such that a male terminal fitting and a female terminal fitting are connected by mounting the male terminal fitting in a male housing, mounting the female terminal fitting in a female housing and connecting the male and female housings.

In the connector of this type, a tapered surface is formed in the front surface of the female housing for guiding a tab on the tip of the male terminal fitting into the female housing. However, if the connector is reduced in size, a tip part of the tab of the male terminal fitting is formed into an elongated and pointed shape. Thus, the tab may be pierced into the tapered surface. If the tab is pierced into tapered surface, the male and female terminal fittings are not connected.

The invention was completed on the basis of the above situation and aims to stabilize a connecting operation of a male terminal fitting and a female terminal fitting.

### SUMMARY

The invention is directed to a connector with a male housing and a female housing disposed to face the male housing. A male terminal fitting is provided in the male housing and is formed with a tab on a front end part. A female terminal fitting is provided in the female housing. The tab is inserted into the female housing and connected to the female terminal fitting by bringing the male housing and the female housing closer to each other in a facing positional relationship. The male housing is provided with a movable member movable with the tab relatively displaceably passed therethrough. A surface of the movable member facing the female housing is formed with a male positioning portion, and a surface of the female housing facing the movable member is formed with a female positioning portion to be fit to the male positioning portion with a front end part of the tab passed through the movable member and held out of contact with the female housing.

If the male housing and the female housing are brought closer to each other with the front part of the tab passed through the movable member, the male positioning portion and the female positioning portion are fit with the tab held out of contact with the female housing. By this fitting, the movable member and the front part of the tab are positioned with respect to the female housing and the female terminal fitting. Therefore a connecting operation of the tab and the female terminal fitting is stabilized.

The male housing may be formed with a receptacle into which the tab and the movable member are accommodated and the female housing is fit. The male positioning portion may be a projection, and the female positioning portion may be recessed. According to this configuration, the receptacle protects the male positioning portion from interference by external matter. Since the female positioning portion is recessed, there is no possibility of deformation caused by interference of external matter.

The movable member may be a flat plate whose plate thickness direction is parallel to a connecting direction of the male housing and the female housing. The male positioning portion may be a plate projecting substantially at a right angle to the movable member. According to this configuration, the movable member may be inclined in a moving process due to the flat plate shape. However, since the male positioning portion is in the form of a plate substantially at a right angle to the movable member, the inclination of the movable member is prevented if the male positioning portion is fit to the female positioning portion.

### BRIEF DESCRIPTION OF DRAWINGS

FIG. 1 is a side view showing a state where a male housing and a female housing are separated in a connector of one embodiment.

FIG. 2 is a section along X-X of FIG. 1.

FIG. 3 is a section along X-X showing a state where the connection of the male housing and the female housing is started.

FIG. 4 is a section along X-X showing a state where a movable member and the female housing are positioned by fitting a positioning protrusion and a positioning recess.

FIG. 5 is a section along Y-Y of FIG. 4.

FIG. 6 is a section along X-X showing a state where the male housing and the female housing are connected.

FIG. 7 is a section along Y-Y showing the state where the male housing and the female housing are connected.

FIG. 8 is a perspective view of the male housing.

FIG. 9 is a front view of the male housing.

FIG. 10 is a perspective view of the movable member.

FIG. 11 is a side view of the movable member.

FIG. 12 is a front view of the female housing.

### DETAILED DESCRIPTION

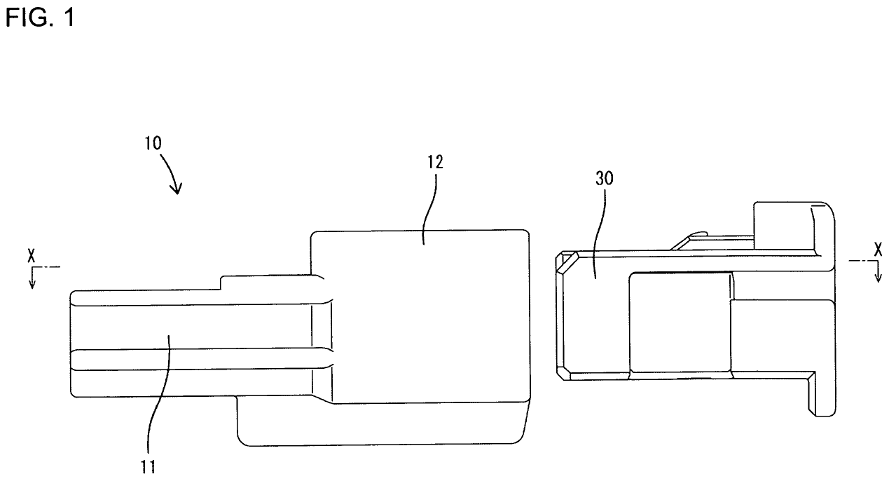

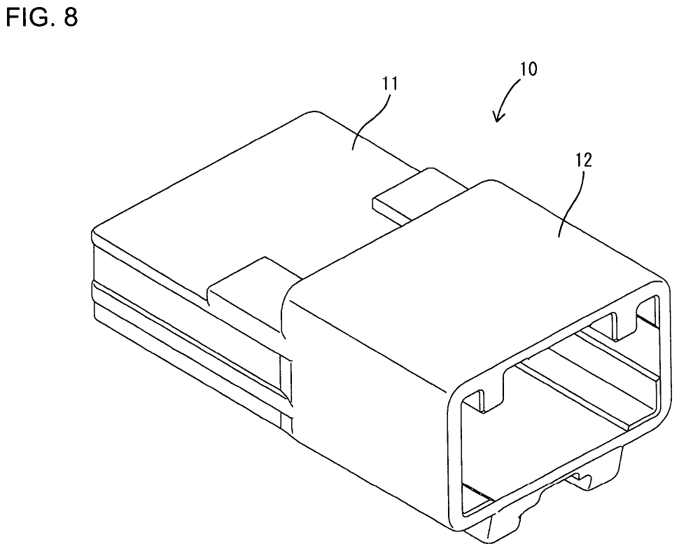

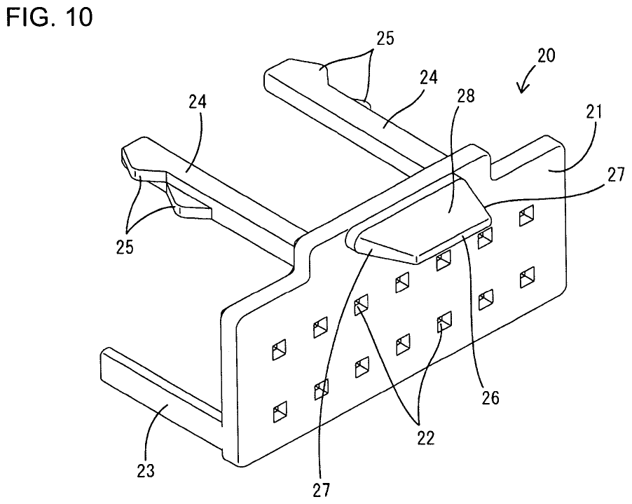

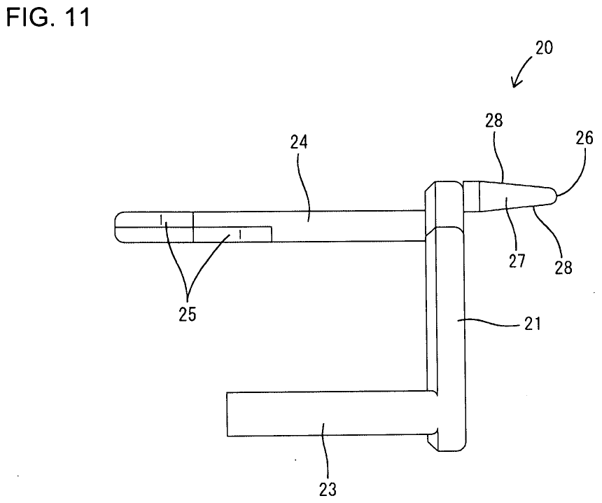

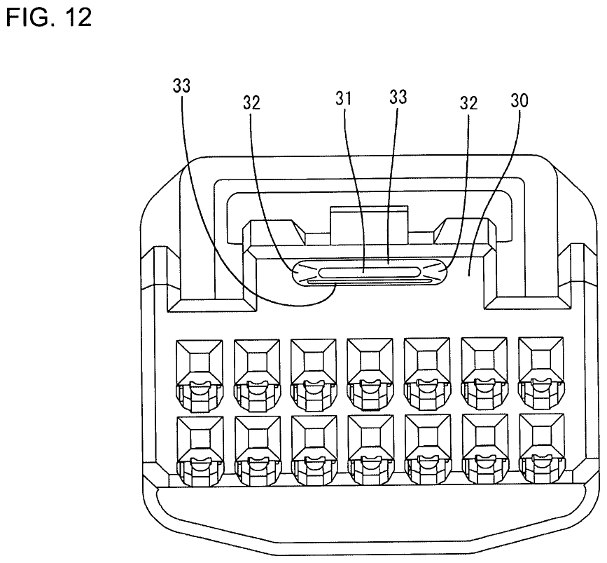

One specific embodiment of the invention is described with reference to FIGS. 1 to 12. Note that, in the following description, a right side in FIGS. 1 to 7 is defined as a front side concerning a front-rear direction of a male housing 10, and a left side in FIGS. 1 to 7 is defined as a front side concerning a front-rear direction of a female housing 30. Upper and lower sides shown in FIGS. 1, 5 and 8 to 12 are directly defined as upper and lower sides concerning a vertical direction.

A connector of this embodiment includes the male housing 10 made of synthetic resin, male terminal fittings 16 mounted in the male housing 10, a movable member 20 made of synthetic resin and mounted in the male housing 10, the female housing 30 made of synthetic resin and connectable to the male housing 10, and female terminal fittings 34 mounted in the female housing 30.

The male housing 10 is a single component including a block-like housing body 11 and a rectangular tubular receptacle 12 projecting forward from the outer periphery of the front end surface of the housing body 11. Terminal accommodation chambers 13 are formed in the housing body 11 while being vertically and laterally aligned. Left and right lock receiving portions 14 are formed on a front end part of the upper surface of a housing body, and a space between the lock receiving portions 14 communicates with the upper end of a rear part of the receptacle 12.

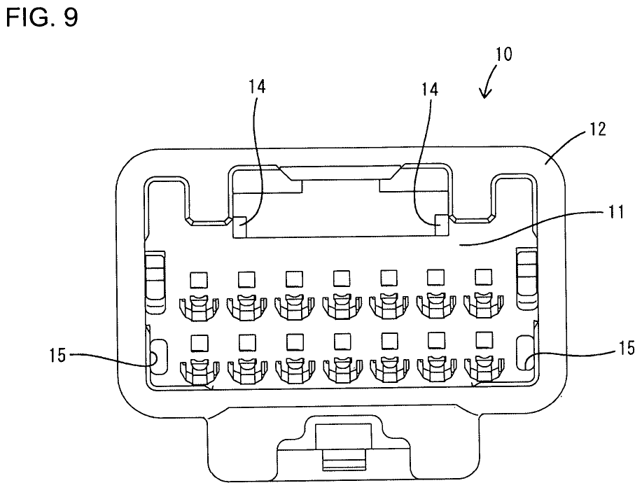

Left and right guide holes 15 are formed in lower end parts of both left and right sides of the housing body (see FIG. 9) and extend in the front-rear direction (direction parallel to a connecting direction of the male housing 10 and the female housing 30). Front ends of the guide holes 15 are open in the back end surface of the receptacle 12 (front end of the housing body 11).

The male terminal fitting 16 is elongated in the front-rear direction and includes a terminal body 17 and a tab 18 elongated forward from the front end of the terminal body 17. A rear end part of the terminal body 17 is fixed conductively to a front end part of a wire 19. The male terminal fitting 16 is mounted in the male housing 10 while being accommodated in the terminal accommodation chamber 13 with a movement of the terminal body 17 in the front-rear direction restricted. The tabs 18 project forward of the front surface of the housing body 11 and are surrounded by the receptacle 12.

The movable member 20 is a single component including a plate body 21, two bilaterally symmetrical guide arms 23, two bilaterally symmetrical locking arms 24 and a positioning protrusion 26 (male positioning portion as claimed). The plate body 21 is a flat plate whose plate thickness direction is parallel to the connecting direction of the housings 10, 30, and is accommodated in the receptacle 12. The outer peripheral shape (front view shape) and dimensions of the plate body 21 are substantially equal to the inner peripheral shape (front view shape) and dimensions of the receptacle 12. The plate body 21 is formed with through holes 22 through which the tabs 18 are passed so as not be displaced in directions intersecting the connecting direction of the housings 10, 30 (vertical direction and lateral direction).

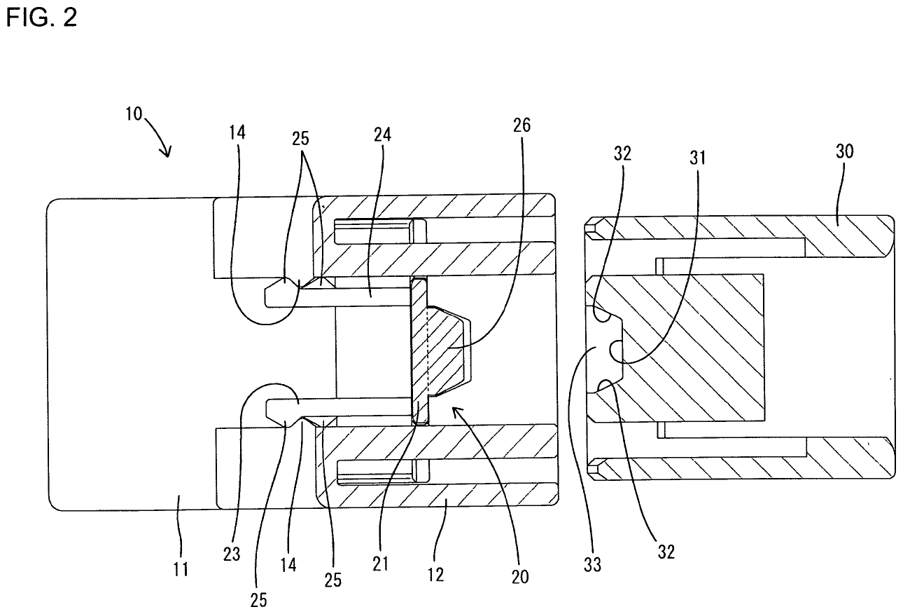

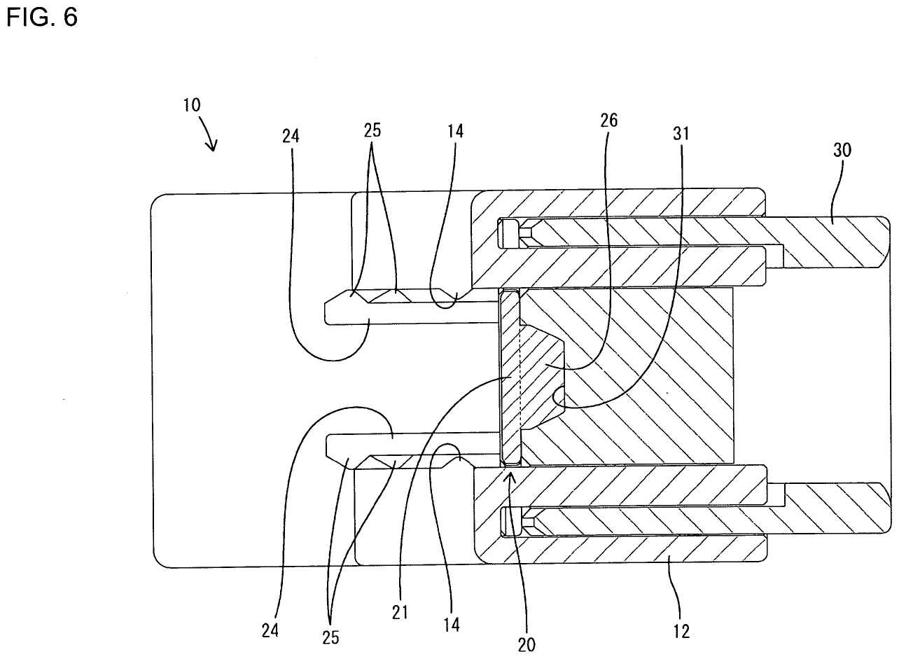

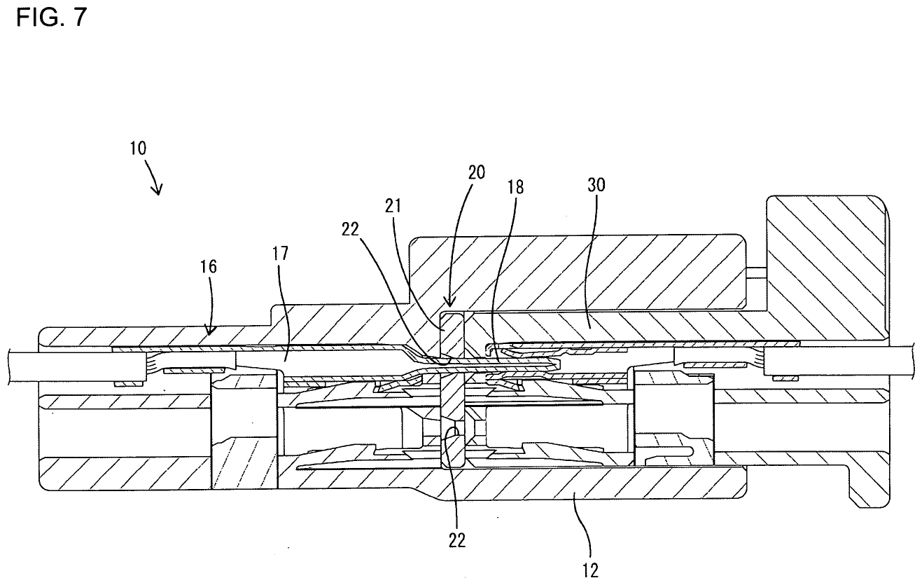

The guide arms 23 are fit into the guide holes 15 of the housing body. The movable member 20 is movable in the front-rear direction between an initial position (see FIGS. 2 to 5) and a connection position (see FIGS. 6 and 7) behind the initial position by sliding the guide arms 23 in contact with the guide holes 15. With the movable member 20 held at the initial position, the plate body 21 is separated forward from the back end surface of the receptacle 12 (front end surface of the housing body) and front projecting ends of the tabs 18 are passed through the respective through holes 22. With the movable member 20 held at the connection position, the plate body 21 is in contact with the front surface of the housing body and base end parts of the tabs 18 are passed through the through holes 22.

The locking arms 24 are cantilevered rearward from an upper end edge of the plate body 21. The locking arms 24 project out and rearward of the receptacle 12 from the rear end part of the plate body 21 and extend along the upper surface of the housing body. Locking projections 25 on rear parts of the locking arms 24 are locked to the lock receiving portions 14 and hold the movable member 20 at the initial position. If a rearward pressing force acts on the movable member 20 in a state where the locking projections 25 and the lock receiving portions 14 are locked, the locking arms 24 resiliently deform toward each other, the locking projections 25 disengage from the lock receiving portions 14 and the movable member 20 starts moving toward the connection position.

The plate body 21 of the movable member 20 is formed with the positioning protrusion 26 for positioning the movable member 20 and the tabs 18 with respect to the female housing 30 and the female terminal fittings 34. The positioning protrusion 26 is cantilevered forward from one position on the front surface (surface facing the female housing 30) of the plate body 21. The positioning protrusion 26 is disposed on an upper end edge part of the plate body 21 in the vertical direction and is disposed in a central part of the plate body 21 in the lateral direction.

The positioning protrusion 26 is a plate aligned at a substantially right angle to the plate body 21 and has plate thickness aligned in the vertical direction. The positioning protrusion 26 has an isosceles trapezoidal shape in a plan view so that a width becomes gradually smaller toward a front end. Both left and right edges of the positioning protrusion 26 serve as guiding edges 27 that are inclined with respect to the connecting direction of the housings 10, 30. The positioning protrusion 26 has a wedge shape in a side view so as to be gradually thinner toward the front. Upper and lower surfaces of the positioning protrusion 26 serve as guiding outer surfaces 28 that are inclined with respect to the connecting direction of the housings 10, 30.

The female housing 30 is in the form of a block as a whole. The female terminal fittings 34 are accommodated in the female housing 30 while being vertically and laterally aligned to face the male terminal fittings 16. In the process of connecting the housings 10, 30, the female housing 30 is fit into the receptacle 12, contacts the plate body 21 of the movable member 20 and moves back in the receptacle 12 integrally with the movable member 20. The housings 10, 30 are connected properly when the movable member 20 is pushed by the female housing 30 to the connection position. Thus, the tabs 18 enter the female housing 30 and connect to the female terminal fittings 34.

The female housing 30 is formed with the positioning recess 31 (female positioning portion as claimed) that can fit to the positioning protrusion 26 for vertically and laterally positioning the movable member 20 and the tabs 18 with respect to the female housing 30 and the female terminal fittings 34 in the process of connecting the housings 10, 30. The positioning recess 31 is formed by recessing the front end surface (surface facing the male housing 10 and the movable member 20) of the female housing 30 into a laterally long slit.

The positioning recess 31 has an isosceles trapezoidal shape in a plan view so that a width becomes gradually smaller toward a rear end (back end of the positioning recess 31). Left and right inner side surfaces of the positioning recess 31 serve as guiding inner side surfaces 32 inclined with respect to the connecting direction of the housings 10, 30. The positioning recess 31 has a wedge shape in a side view so that a height becomes gradually smaller toward the rear end. Upper and lower surfaces of the positioning recess 31 serve as guiding inner surfaces 33 inclined with respect to the connecting direction of the housings 10, 30.

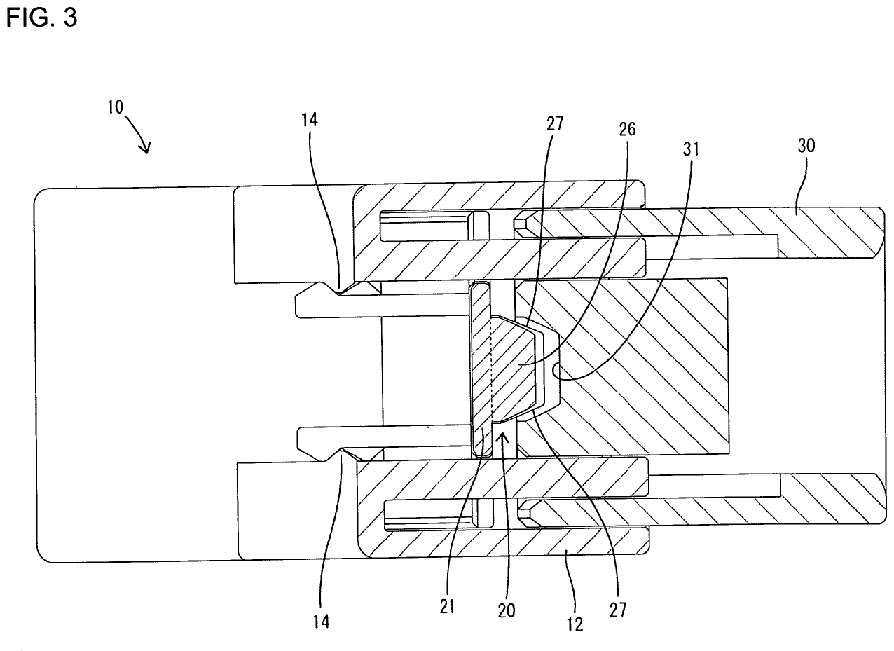

In connecting the housings 10, 30, the movable member 20 is held at the initial position in advance with the housings 10, 30 separated (see FIG. 2). The connection of the housings 10, 30 is started from this state, and the female housing 30 is fit into the receptacle 12. As the connection proceeds, a front part of the positioning protrusion 26 starts entering the positioning recess 31, as shown in FIG. 3. During this time, the tabs 18 are held out of contact with the female housing 30 (state where the front surface of the female housing 30 has not yet reached the front ends of the tabs 18).

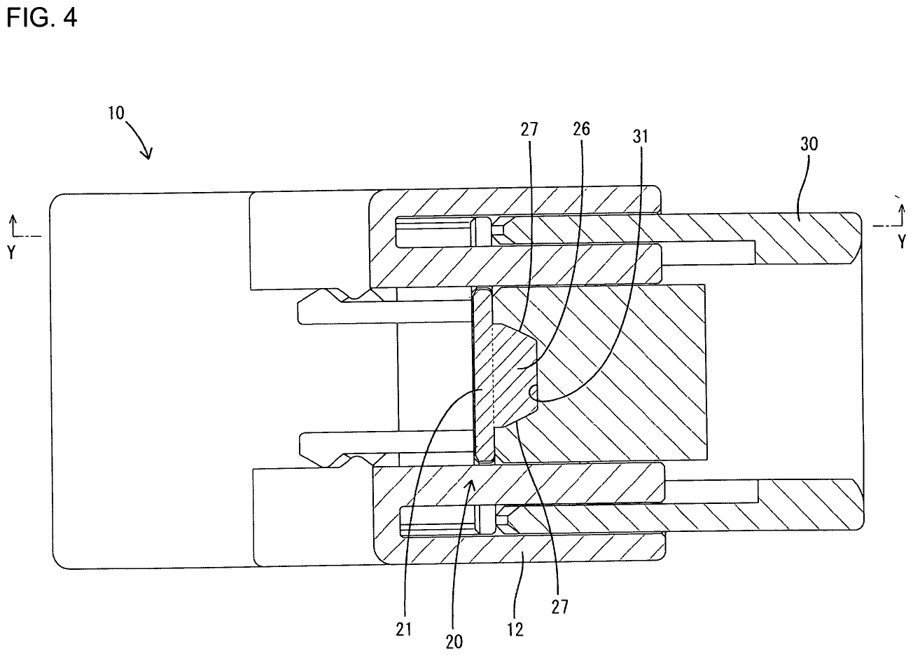

When the connection of the housings 10, 30 proceeds farther from this state, the entire positioning protrusion 26 is fit into the positioning recess 31 and the front end surface of the female housing 30 comes into surface contact with the front surface of the movable member 20 (plate body 21), as shown in FIG. 4. At this time, the movable member 20 remains held at the initial position.

In the process of fitting the positioning protrusion 26 and the positioning recess 31, the guiding edges 27 of the positioning protrusion 26 and the guiding inner side surfaces 32 of the positioning recess 31 slide in contact to position the plate body 21 and the female housing 30 laterally. Simultaneously, the guiding outer surfaces 28 of the positioning protrusion 26 and the guiding inner surfaces 33 of the positioning recess 31 slide in contact to position the plate body 21 and the female housing 30 vertically.

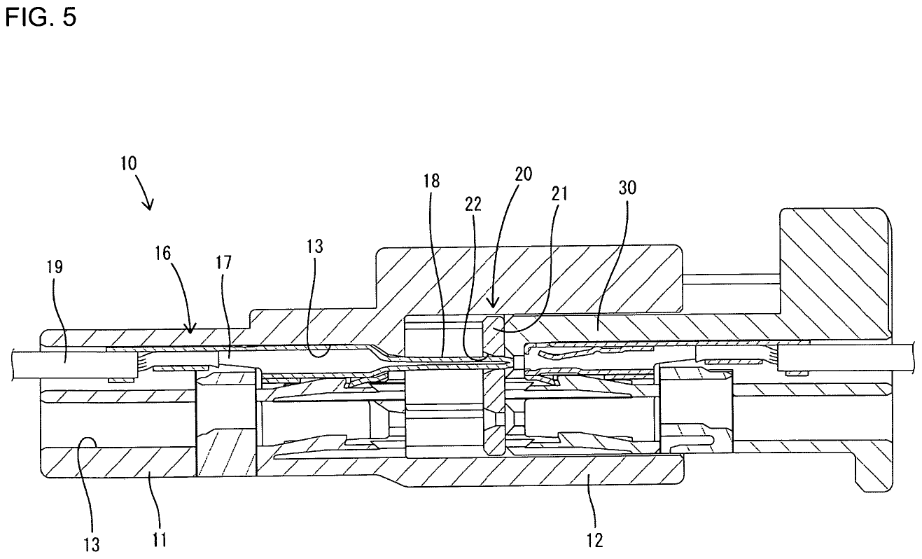

With the plate body 21 (movable member 20) and the female housing 30 positioned by fitting the positioning protrusion 26 and the positioning recess 31 in this way, the front ends of the tabs 18 are not in contact with the female housing 30 (see FIG. 5). When the connection of the housings 10, 30 proceeds farther from this positioned state, the locking arms 24 resiliently deform to disengage the locking projections 25 from the lock receiving portions 14. Thus, the movable member 20 moves toward the back in the receptacle 12 integrally with the female housing 30.

As the movable member 20 moves, the passing positions of the tabs 18 through the through holes 22 move from the front ends toward the base ends (toward the rear ends) and the tabs 18 are inserted into the female housing 30. The plate body 21 is positioned vertically and laterally with respect to the female housing 30, the front end parts of the tabs 18 passed through the through holes 22 of the plate body 21 also are positioned vertically and laterally with respect to the female housing 30. Thus, the tabs 18 are inserted into the female housing 30 and connected to the female terminal fittings 34 without contacting the front end surface of the female housing 30. The housings 10, 30 are connected properly when the plate body 21 contacts the back end surface of the receptacle 12 (front end surface of the housing body 11), as shown in FIGS. 6 and 7.

The connector of this embodiment includes the male housing 10, the male terminal fittings 16 provided in the male housing 10, the female housing 30 disposed to face the male housing 10 and the female terminal fittings 34 provided in the female housing 30. If the male housing 10 and the female housing 30 are brought closer to each other in a facing positional relationship, the tabs 18 on the front parts of the male terminal fittings 16 enter the female housing 30 and connect to the female terminal fittings 34.

The connecting operation of the tabs 18 and the female terminal fittings 34 is stabilized by providing the male housing 10 with the movable member 20 that moves with the tabs 18 relatively displaceably passed therethrough. The surface of the movable member 20 facing the female housing 30 is formed with the positioning protrusion 26, and the surface of the female housing 30 facing the movable member 20 is formed with the positioning recess 31. The positioning protrusion 26 and the positioning recess 31 are fit to each other with the front parts of the tabs 18 passed through the plate body 21 of the movable member 20 and held out of contact with the female housing 30.

The male housing 10 and the female housing 30 can be brought closer to each other with the front end parts of the tabs 18 passed through the movable member 20. Thus, the male positioning portion and the female positioning portion are fit with the tabs 18 held out of contact with the female housing 30. By this fitting, the movable member 20 and the front parts of the tabs 18 are positioned vertically and laterally with respect to the female housing 30 and the female terminal fittings 34 to stabilize the connecting operation of the tabs 18 and the female terminal fittings 34.

Further, the male housing 10 is formed with the receptacle 12 into which the tabs 18 and the movable member 20 are accommodated and the female housing 30 is fit. The male positioning portion of the movable member 20 is a projection and the female positioning portion of the female housing 30 is the recessed positioning recess 31. According to this configuration, the receptacle 12 protects the positioning protrusion 26 from interference with external matter. The positioning recess 31 of the female housing 30 is recessed and cannot be deformed by interference with external matter.

Further, the plate body 21 of the movable member 20 is a flat plate whose plate thickness is parallel to the connecting direction of the male housing 10 and the female housing 30. Additionally, the positioning protrusion 26 is a plate projecting substantially at a right angle to the plate body 21. Since the plate body 21 (movable member 20) is a flat plate, the plate body 21 may be inclined in a moving process in the receptacle 12. However, the positioning protrusion 26 is a plate substantially at a right angle to the plate body 21. Thus, the inclination of the plate body 21 (movable member 20) is prevented as the positioning protrusion 26 is fit into the positioning recess 31.

The invention is not limited to the above described and illustrated embodiment. For example, the following embodiments are also included in the scope of the invention.

The male positioning portion is a projection and the female positioning portion is recessed in the above embodiment. However, the male positioning portion may be recessed and the female positioning portion may be in the form of a projection.

Although the movable member is a flat plate in the above embodiment, the movable member may include a peripheral wall that can slide in contact with the inner periphery of the receptacle.

Although the male positioning portion is a plate projecting substantially at a right angle to the movable member in the above embodiment, the male positioning portion may be a rib-like projection or a boss-like projection.

Although the male positioning portion is near the outer peripheral edge of the movable member in the above embodiment, the male positioning portion may be disposed in a central part of the front surface of the movable member.

Although one male positioning portion and one female positioning portion are formed in the above embodiment, a plurality of the male positioning portions and a plurality of the female positioning portions may be formed.

### LIST OF REFERENCE SIGNS

10—male housing

12—receptacle

16—male terminal fitting

18—tab

20—movable member

26—positioning protrusion (male positioning portion)

30—female housing

31—positioning recess (female positioning portion)

34—female terminal fitting

1. A connector, comprising:
a male housing;
a male terminal fitting provided in the male housing and formed with a tab on a front end part;
a female housing disposed to face the male housing; and
a female terminal fitting provided in the female housing;
the tab being inserted into the female housing and connected to the female terminal fitting by bringing the male housing and the female housing closer to each other in a facing positional relationship;
wherein:
the male housing is provided with a movable member movable with the tab relatively displaceably passed therethrough;
a surface of the movable member facing the female housing is formed with a male positioning portion;
a surface of the female housing facing the movable member is formed with a female positioning portion to be fit to the male positioning portion with a front end part of the tab passed through the movable member and held out of contact with the female housing;
the male positioning portion projects forward from the surface of the movable member facing the female housing and is shaped such that a width and a thickness become gradually smaller toward a front end side; and
the female positioning portion is formed by recessing the surface of the female housing facing the movable member and shaped such that a width and a height become gradually smaller toward a back side.

2. The connector of claim 1, wherein:
the male housing is formed with a receptacle into which the tab and the movable member are accommodated and the female housing is fit.

3. The connector of claim 2, wherein:
the movable member is in the form of a flat plate whose plate thickness direction is parallel to a connecting direction of the male housing and the female housing; and
the male positioning portion is in the form of a plate projecting substantially at a right angle to the movable member.

4. The connector of claim 1, wherein:
the movable member is in the form of a flat plate whose plate thickness direction is parallel to a connecting direction of the male housing and the female housing; and
the male positioning portion is in the form of a plate projecting substantially at a right angle to the movable member.
